(19) United States
(12) Patent Application Publication
(10) Pub. No.: US 2013/0188209 A1
(43) Pub. Date: Jul. 25, 2013

(54) RECORDING APPARATUS

(71) Applicant: SEIKO EPSON CORPORATION, Tokyo (JP)

(72) Inventors: Masayuki HORIKAWA, Matsumoto-shi (JP); Kenji OSHIMA, Kamiina-gun (JP); Hidenao SUZUKI, Matsumoto-shi (JP)

(73) Assignee: SEIKO EPSON CORPORATION, Tokyo (JP)

(21) Appl. No.: 13/746,958

(22) Filed: Jan. 22, 2013

(30) Foreign Application Priority Data
Jan. 23, 2012 (JP) 2012-011009
Jan. 23, 2012 (JP) 2012-011011

(51) Int. Cl. H04N 1/00

(52) U.S. Cl. CPC H04N 1/00546
USPC 358/1.13

(57) ABSTRACT

A recording apparatus includes: an apparatus main body including a recording device that performs a recording operation on a medium; a scanner unit pivotably mounted on a top portion of the apparatus main body and configured to be openable and closable when the scanner unit is tilted; and an operation panel unit provided on the scanner unit so as to tilt together with the scanner unit. When the scanner unit is in a closed position, the operation panel unit defines a front face of the recording apparatus and a lower edge of the operational panel unit defines an ejection port that ejects the medium recorded by the recording device.

### BACKGROUND

1. Technical Field

The present invention relates to a recording apparatus typified by a facsimile and a printer and more particularly relates to a recording apparatus including a scanner unit pivotably mounted on a top portion of an apparatus main body.

2. Related Art

In a recording apparatus typified by a facsimile and a printer, there is a so-called multifunction apparatus including an image-reading function as well as a recording function. That is, a scanner unit is provided on a top portion of a main body of a recording apparatus that records data on a recording paper.

The scanner unit is pivotably mounted on the main body of the recording apparatus and can take an open position and a closed position when the scanner unit is tilted. The scanner unit maintains the closed position under an usual operation. However, for an unusual operation, for example, an operation of clearing a paper jam in which the paper jam occurs in the main body of the recording apparatus, or an operation of replacing an ink cartridge, the scanner unit is tilted to the open position (for example, JP-A-2011-242910).

In a recording apparatus disclosed in JP-A-2011-242910, an operation panel is located on a front face of an apparatus main body so that a panel face defines an apparatus front face and a lower edge of the operation panel defines a paper ejection port. Thus, even if a scanner unit is tilted to the open position, it is possible for a user to view the panel face more satisfactorily than in the case where the operation panel is located on the top face of the scanner unit. That is, in the case where the operation panel is provided on the top face of the scanner unit, the operation panel is disposed on the opposite side from the scanner unit with respect to a user when the scanner unit is tilted to the open position. This lowers viewability. However, if the operation panel is located at the apparatus front face, such a problem may not occur.

Since the scanner unit is tilted to the open position in order to clear a paper jam or replace an ink cartridge, as described above, it is preferable to open the scanner unit as much as possible in view of facilitating such operations. However, there is a limitation on the opening angle of the scanner unit due to, for example, the design of the hinge mechanism that pivotably couples the scanner unit to the apparatus main body.

### SUMMARY

An advantage of some aspects of the invention is that ease of performing various kinds of operations in the case where a scanner unit is in an open position can be further improved by using a structure in which the scanner unit is mounted on a top portion of an apparatus main body and an operation panel is located on a front face of the apparatus.

A recording apparatus according to an aspect of the invention includes: an apparatus main body including a recording device that performs a recording operation on a medium; a scanner unit pivotably mounted on a top portion of the apparatus main body and configured to be openable and closable when the scanner unit is tilted; and an operation panel unit provided on the scanner unit so as to tilt together with the scanner unit. When the scanner unit is in a closed position, the operation panel unit defines a front face of the recording apparatus and a lower edge of the operation panel unit defines an ejection port that ejects the medium recorded by the recording device.

According to the aspect, since the operation panel unit that defines the front face of the recording apparatus and in which the lower edge of the operation panel unit defines the medium ejection port when the scanner unit is in the closed position is provided on the scanner unit, an upper part of the medium ejection port is widely open when the scanner unit is tilted to the open position.

Accordingly, it is possible to ensure a large working space for clearing a paper jam, replacing an ink cartridge, or the like without increasing the opening angle of the scanner unit. The ease of performing the various kinds of operations can be enhanced.

It is preferable that the apparatus main body include an ejection unit that is located at a side near the front face of the recording apparatus away from the recording device and that ejects the medium toward the front face of the recording apparatus. The ejection unit includes a first roller and a second roller that contacts the first roller in a downward direction. The second roller is supported by a frame that extends laterally in the recording apparatus. An upper edge of the frame defines a lower edge of an access port when accessing an inner area of the recording apparatus from the front face of the recording apparatus in a front elevation view of the recording apparatus.

According to the preferable aspect, since the upper edge of the frame that supports the second roller defines the lower edge of the access port when accessing the inner area of the recording apparatus from the front face thereof in the front elevation view of the recording apparatus, there are no constituent elements in the apparatus main body above a medium transport path that extends from the medium ejection port to the frame located on the inner part of the recording apparatus when the scanner unit is tilted to the open position. Thus, it is possible to further enhance operability when clearing a paper jam.

It is preferable that heights of top faces of a right side structural member and a left side structural member that define the right and left edges of the ejection port decrease toward the front face of the recording apparatus.

According to the preferable aspect, since the heights of top faces of the right side structural member and the left side structural member that define the right and left edges of the ejection port decrease toward the front face of the recording apparatus, it is possible for a user to insert their hand into the inner part of the recording apparatus more readily when the scanner unit is tilted to the open position. This can further enhance the operability.

It is preferable that the operation panel unit be pivotably mounted on the scanner unit.

According to the preferable aspect, since the operation panel unit is pivotably mounted on the scanner unit, it is possible to ensure a larger working space for the various kinds of operations such as an operation of clearing a paper jam, an operation of replacing an ink cartridge, and the like, when the scanner unit is tilted to the open position and the operation panel unit is tilted. This can further enhance the operability.

It is preferable that a panel face of the operation panel unit is inclined upward when the scanner unit is tilted to an open position by a given opening angle.

According to the preferable aspect, since the panel face of the operation panel unit is inclined upward when the scanner unit is tilted to the open position, the panel face approaches the positions of the user's eyes and ends up being opposite the face of the user. Consequently, the user can view the panel face more easily and can operate an operation panel more easily. Thus, it is possible to further enhance viewability and operability of the operation panel in the open position of the scanner unit while suppressing an increase in the cost of the recording apparatus without providing any tilt mechanism.

It is preferable that a direction in which the operation panel of the operation panel unit is pushed intersect a direction in which the scanner unit closes when a user operates the operation panel of the operation panel unit while the scanner unit is in an open position.

According to the preferable aspect, since the direction in which the operation panel of the operation panel unit is pushed intersects the direction in which the scanner unit closes when the user operates the operation unit while the scanner unit is in the open position, the force that pushes the operation panel is not applied directly in the direction in which the scanner unit closes and it is possible to prevent the scanner unit from being closed when operating the operation panel. It is also possible to give the user a feeling of positive and stable operation when the user operates the operation panel.

It is preferable that a user interface of the operation panel of the operation panel unit be changed in accordance with the open and closed positions of the scanner unit.

According to the preferable aspect, since the user interface of the operation panel of the operation panel unit is changed in accordance with the open and closed positions of the scanner unit, it is possible to construct a more user-friendly interface.

### BRIEF DESCRIPTION OF THE DRAWINGS

The invention will be described with reference to the accompanying drawings, wherein like numbers reference like elements.

FIG. 1 is an external perspective view of an ink jet printer according to an embodiment of the invention, illustrating a scanner unit in a closed position.

FIG. 2 is an external perspective view of the ink jet printer according to the embodiment of the invention, illustrating the scanner unit in an open position.

FIG. 3 is a front elevation view of the ink jet printer according to the embodiment of the invention, illustrating the scanner unit in the open position.

FIG. 4 is a schematic side section view of the ink jet printer according to the embodiment of the invention, illustrating the scanner unit in the open position.

FIG. 5 is a perspective view of a panel unit from the backside of the panel unit.

FIG. 6 is a schematic side section view of the ink jet printer according to another embodiment of the invention, illustrating the scanner unit in the open position.

FIG. 7A is an explanatory view of a button and indicators that constitute an operation panel.

FIG. 7B is an explanatory view of the button and indicators that constitute the operation panel.

### DESCRIPTION OF EXEMPLARY EMBODIMENTS

Embodiments of the invention will be described below by referring to the drawings. It should be noted that the invention is not limited to the embodiments described below, various alterations can be made within the scope of the claims, and these alterations can be included in the invention. The following embodiments of the invention are predicated on the above precondition.

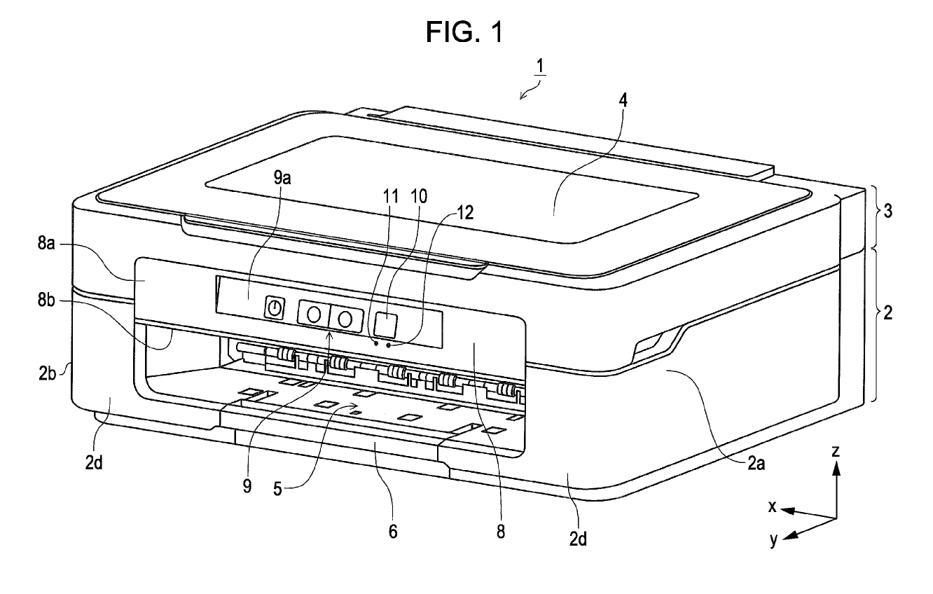

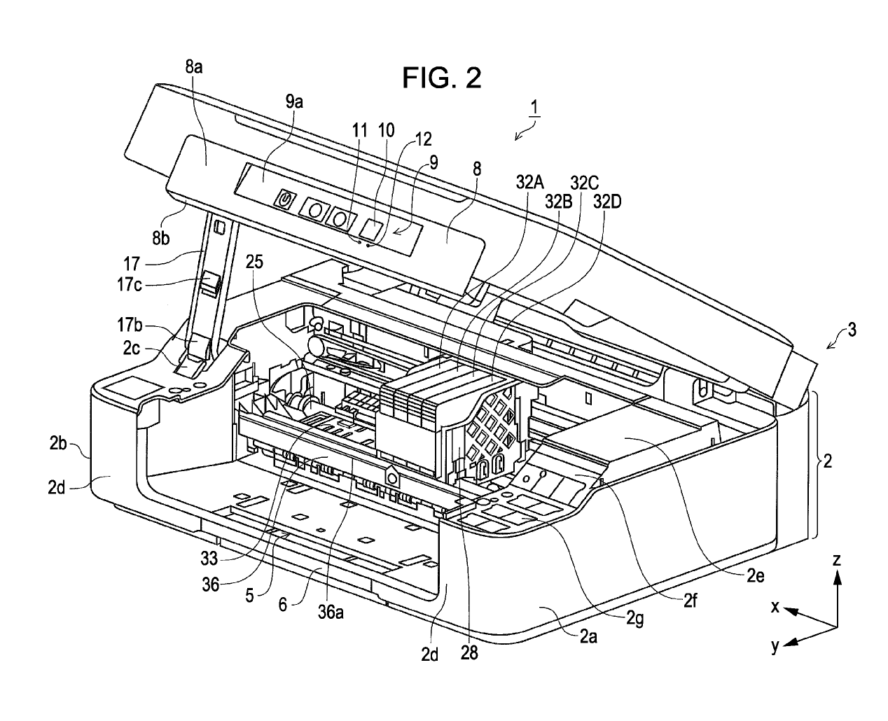

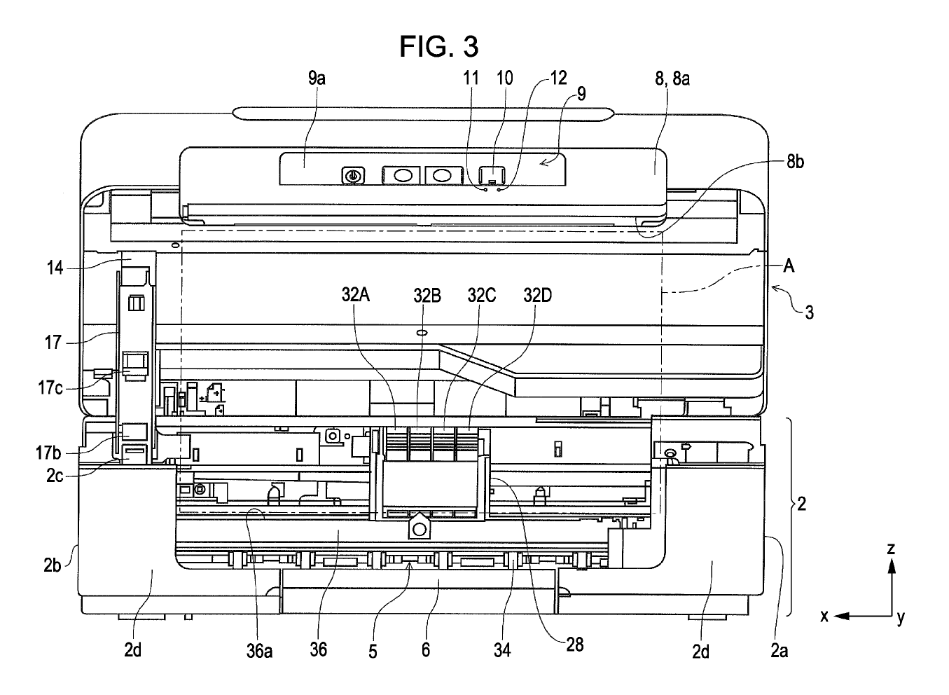

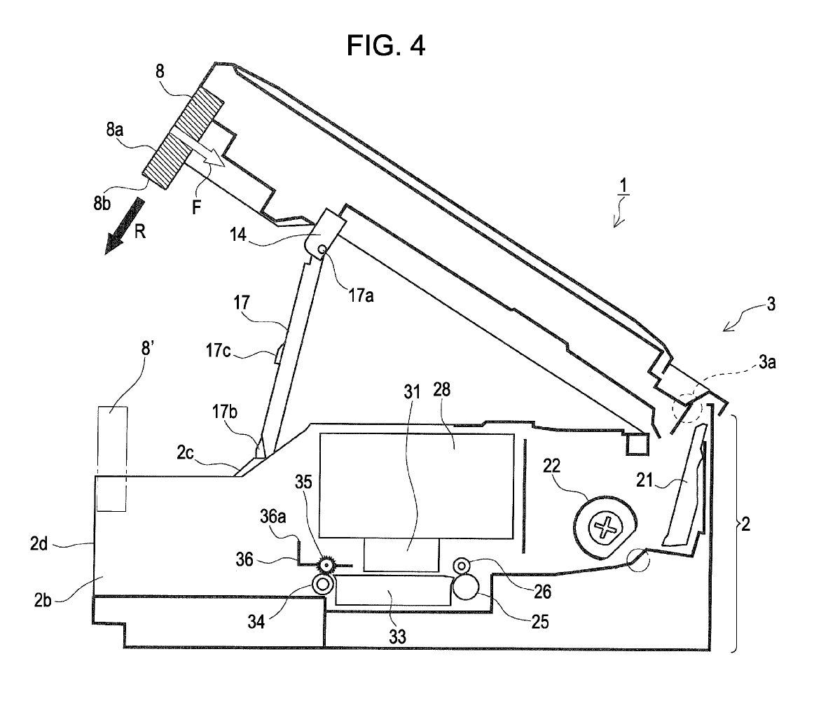

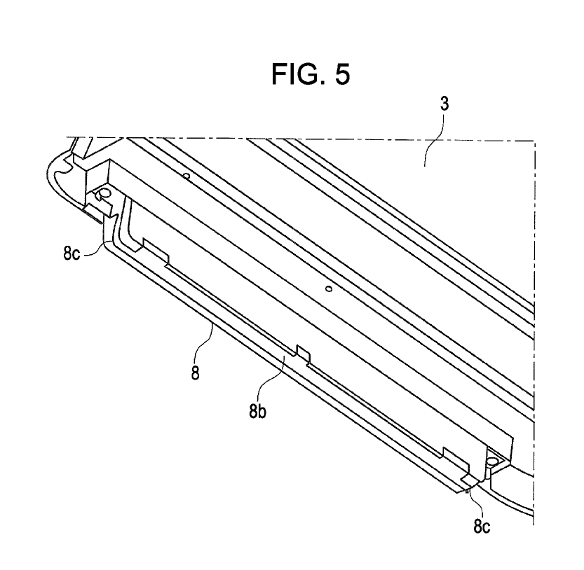

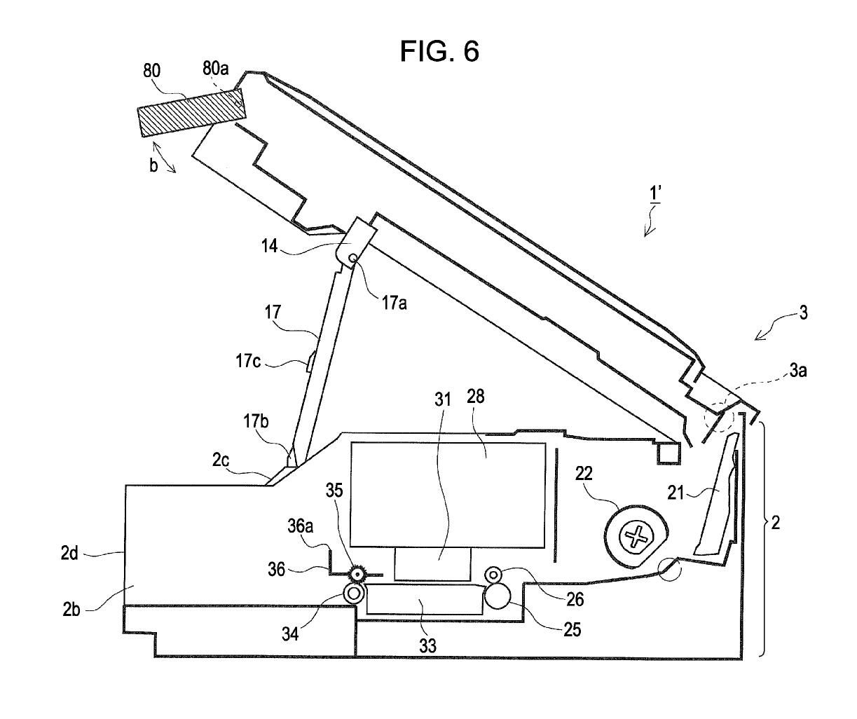

FIG. 1 is an external perspective view of an ink jet printer 1 according to an embodiment of the invention, illustrating a scanner unit 3 in a closed position. FIG. 2 is an external perspective view of the ink jet printer 1, illustrating the scanner unit 3 in an open position. FIG. 3 is a front elevation view of the ink jet printer 1, illustrating the scanner unit 3 in the open position. FIG. 4 is a side section view of the ink jet printer 1, illustrating the scanner unit 3 in the open position. FIG. 5 is a perspective view of a panel unit 8 from the backside of the panel unit 8. FIG. 6 is a side section view of the ink jet printer 1′ according to another embodiment of the invention, illustrating the scanner unit 3 in the open position. FIGS. 4 and 6 are schematic side section views and elements unnecessary for explanation may be omitted in FIGS. 4 and 6.

In FIGS. 1 to 4, the ink jet printer 1 includes a recording unit (an apparatus main body) 2 that performs ink jet recording on a medium such as recording paper, and a scanner unit 3 pivotably mounted on a top portion of the recording unit 2. That is, the ink jet printer 1 is a multifunction apparatus that has a scanner function as well as an ink jet recording function.

The recording unit 2 forms an apparatus main body of the ink jet printer 1. The scanner unit 3 is pivotably mounted on the recording unit 2 and can take a closed position (FIG. 1) and an open position (FIGS. 2 to 4) when the scanner unit 3 is tilted. A pivot axis 3a of the scanner unit 3 is indicated in FIG. 4.

When the scanner unit 3 is tilted to the open position, it is possible to carry out, for example, an operation of replacing ink cartridges 32A, 32B, 32C, and 32D mounted on a carriage 28, an operation of clearing a paper jam (an operation of removing a recording sheet), and the like.

When the scanner unit 3 is tilted to the open position, the scanner unit 3 maintains the open position by an arm (a support pole, a dashboard, or a support member) 17. An end (an upper end) of the arm 17 is pivotably connected to the scanner unit 3 through an arm attaching portion 14 (see FIGS. 3 and 4) and a pivot axis 17a (FIG. 4) to the scanner unit 3. When the scanner unit 3 is in the open position, an engaging portion 17b on the other end (a lower end) of the arm 17 is received by an arm support portion 2c provided on the recording unit 2. Thus, the scanner unit 3 maintains the open position.

The arm 17 is provided with an engaging portion 17c away from the engaging portion 17b in the upper direction. The engaging portion 17c can maintain the scanner unit 3 in a half-open position temporarily. Thus, it is possible to prevent the scanner unit 3 from being tilted from the completely open position (FIGS. 2 to 4) to the completely closed position (FIG. 1) in one stroke, thereby preventing the occurrence of collision sounds or breakage of members of the ink jet printer 1.

An upper cover 4 can be opened and closed on the scanner unit 3. When the cover 4 is tilted to an open position, a document table (not shown) will appear on the scanner unit 3.

On the apparatus front face, an ejected-paper tray 6 receives an ejected paper after recording. The ejected-paper tray 6 is constructed into a drawer-type structure. FIGS. 1 to 3 illustrate the ejected-paper tray 6 in a retracted position.

An operation panel 9 includes a power source button, an operation button that performs various kinds of print setting and recording operations, and a display that performs a preview display concerning contents of a print-setting and a print image. A panel unit 8 includes the operation panel 9. Indicators 11 and 12 on the operation panel 9 can be on, off, or flashing. The indicator 12 indicates an ink-out condition while the indicator 11 indicates a paper jam condition or an out-of-paper condition. An operation button 10 is pushed down when replacing an ink cartridge, clearing jammed paper, or inserting paper.

The panel unit 8 including the operation panel 9 is mounted on the scanner unit 3. The panel unit 8 is displaced (tilted) together with the scanner unit 3 in response to tilting of the scanner unit 3. As illustrated in FIG. 5, a lower corner 8c of the panel unit 8 is formed into a smoothly round shape. Accordingly, when a user closes the scanner unit 3, even if any one of their fingers is pinched between the recording unit 2 and the panel unit 8, the finger is not hurt.

A recording head 31 is provided on the bottom surface of a carriage 28 (see FIG. 4). When the carriage 28 moves in the width direction of paper, the recording head 31 ejects an ink onto paper so as to record data.

As illustrated in FIG. 4, a support member 33 that supports paper is disposed at a position opposing the recording head 31. A transport drive roller 25 and a transport follower roller 26 that constitute a paper transport unit are located at an upstream side of the support member 33.

A feed roller 22 and a paper support member 21 that constitute a paper feed unit are located further upstream of the transport drive roller 25 and transport follower roller 26. When the paper support member 21 is swung about an upper swing axis (not shown), the paper support member 21 can switch over between a position at which the mounted paper is pressed onto the feed roller 22 and a position at which the paper is moved away from the feed roller 22. When the feed roller 22 rotates, it feeds the paper toward the transport drive roller 25 and transport follower roller 26 in the downstream direction.

First rollers or ejection drive rollers 34 and second rollers or ejection follower rollers 35 are located downstream of the recording head 31 and support member 33. The ejection drive rollers 34 and ejection follower rollers 35 constitute an ejection unit that transports the recorded paper toward the ejected-paper tray 6 for the ejected paper. The ejection follower rollers 35 contact the ejection drive roller 34 and rotate together with the ejection drive rollers 34. The ejection follower rollers 35 are arranged on a frame member 36 that extends in the paper width direction (in the lateral direction of the apparatus, namely in a direction perpendicular to the plane of FIG. 4) and are spaced away from each other by suitable distances in the paper width direction.

In the ink jet printer 1 of the invention including the above structure, when the scanner unit 3 is tilted to the closed position, the panel unit 8 including the operation panel 9 forms a front face of the apparatus. A panel face 8a of the panel unit 8 (the operation panel 9) constitutes the front face of the apparatus together with a front face 2d provided with a paper ejection port 5 among peripheral faces around the recording unit 2. In this embodiment, the front face of the apparatus is substantially an upright face and the panel face 8a is substantially flush with the front face 2d.

A face (an operation face 9a) provided with the operation button 10 and indicators 11 and 12 that is part of the panel face 8a is inclined upward further than the panel face 8a in this embodiment. Thus, when the scanner unit 3 is closed (the panel face 8a stands upright), it is easy for a user to view the operation surface 9a. Also, when the scanner unit 3 is opened, it is easier for the user to view the operation surface 9a.

When the scanner unit 3 is in the closed position, a lower edge 8b of the panel unit 8 defines the paper ejection port 5. Consequently, since it is not necessary to provide any frame in order to define an upper portion of the paper ejection port 5, the ink jet printer 1 can be simplified. Also, since the panel unit 8 is provided on the scanner unit 3 and tilts together with the scanner unit 3, when the scanner unit is tilted to the open position, all of the upper inner part starting from the paper ejection port 5 is exposed, as illustrated in FIGS. 2 to 4.

The reference symbol A in FIG. 3 denotes a space (hereinafter referred to a “working space”) in which the user can insert their hand into the apparatus when the scanner unit 3 is tilted to the open position. When the scanner unit 3 is opened, for example, as illustrated in FIG. 3, the panel unit 8 does not exist in the working space A, thereby defining a large working space extending from the front face of the apparatus to the inner part thereof. In particular, the reference symbol 8′ denotes an area occupied by the panel unit 8 when the panel unit 8 is in the closed position. This area is completely exposed when the scanner unit 3 is tilted to the open position.

Thus, it is possible to ensure a large space for performing operations such as an operation of clearing a paper jam, and an operation of replacing an ink cartridge and it is possible to enhance operability of the scanner unit 3 without increasing the opening angle of the scanner unit 3. Since the space above the ejected-paper tray 6 is increased, it is possible to readily remove small sheets of paper out of the ejected-paper tray 6.

In particular, in this embodiment, an upper edge 36a of the frame member 36 that supports the ejection follower rollers 35 defines a lower edge of an access port (a lower edge of the working space A) when the user accesses the inner area of the apparatus from the frame member 36a in a front elevation view of the apparatus illustrated in FIG. 3. Accordingly, when the scanner unit 3 is opened, there is not any constituent element in the recording unit (the apparatus main body) 2 above a medium transport path from the paper ejection port 5 to the frame member 36 located at the inner part of the apparatus. Thus, it is possible to further enhance operability when clearing a paper jam.

In addition, in this embodiment, the heights of the top faces of a right side structure 2a and a left side structure 2b that define the right and left edges of the paper ejection port 5 decrease toward the front face of the apparatus. For example, as illustrated in FIG. 2, the top face of the right side structure 2a includes a rear side top surface portion 2e, a ramp surface portion 2f that goes down from the rear side top face portion 2e toward the front side of the apparatus, and a front side top face portion 2g that is lower than the rear side top face portion 2e.

Accordingly, when the scanner unit 3 is tilted to the open position, the front face of the apparatus is open significantly. This will make it easier for the user to insert their hand into the working space A.

It should be noted that the embodiment described above is an example. The invention is not limited to the embodiment. Although the panel unit 8 is fixed on the scanner unit 3 in the above embodiment, for example, the panel unit 8 may be pivotably connected to the scanner unit 3. FIG. 6 illustrates an ink jet printer 1′ in which a panel unit 80 is connected through a pivot axis 80a to the panel unit 3.

The panel unit 80 is connected to the scanner unit 3 so as to be pivotable in clockwise and counterclockwise directions in FIG. 6 (directions illustrated by a double-head arrow b). When the scanner unit 3 is tilted to the open position and the panel unit 80 is tilted to the clockwise direction, the working space A (FIG. 3) becomes larger, thereby facilitating clearing of a paper jam and replacement of an ink cartridge.

In the ink jet printer 1 of the invention, the panel face 8a of the operation panel 9 (the panel unit 8) inclines upward when the scanner unit 3 is tilted to the open position by a given opening angle (less than 90 degrees), as illustrated in FIGS. 2 to 4. That is, since the panel face 8a approaches the position of the user's eyes and ends up being opposite the user's face, the user can view the operation panel 9 more readily and can operate the operation panel 9 more easily. Consequently, it is possible to further enhance the viewability and operability of the operation panel 9 when the scanner unit 3 is in the open position while suppressing an increase in the cost of the apparatus and without providing any tilt mechanism.

When the user operates the operation panel 9 while the scanner unit 3 is in the open position, the direction (a direction illustrated by an arrow F in FIG. 4) in which the operation panel 9 (the panel unit 8) is pushed intersects the direction (a direction illustrated by an arrow R in FIG. 4) in which the scanner unit 3 closes. In particular, in this embodiment, the pushing direction F is directed straight toward the pivot axis 3a of the scanner unit 3.

Thus, since the force of pushing the operation panel 9 in the direction F is not applied directly in the closing direction R of the scanner unit 3, it is possible to prevent the scanner unit 3 from being closed, even if the user operates the operation panel 9. Furthermore, it is possible to give the user a feeling of positive and stable operation when the user operates the operation panel 9.

It may be preferable to configure the indicators 11 and 12 on the operation panel 9 to operate in accordance with the open and closed positions of the scanner unit 3. That is, it may be preferable to configure the indicators 11 and 12 so as to change in accordance with the scanner unit 3 being opened or closed (so as to be switched over in accordance with the scanner unit 3 being in the open position or closed position).

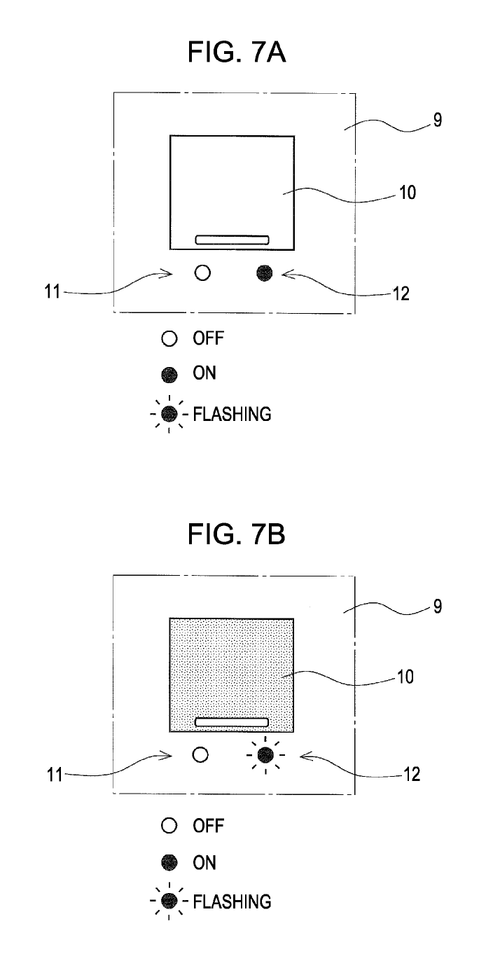

FIGS. 7A and 7B are explanatory views that illustrate states of the operation button 10 and the indicator 12 that constitute the operation panel 9. FIG. 7A illustrates a state in which the scanner unit 3 is in the closed position and FIG. 7B illustrates a state in which the scanner unit 3 is in the open position.

For example, the indicator 12 illustrated in FIGS. 7A and 7B indicates that one of ink cartridges runs out of ink. FIG. 7A illustrates the state in which the cartridge runs out of ink when the scanner unit 3 is in the closed position. At this time, the indicator 12 indicates that there is no more ink by switching on or lighting up. In this embodiment, the operation button 10 has a self-light-emitting function. The operation button 10 does not emit light when the scanner unit 3 is in the closed position.

FIG. 7B illustrates a state of the indicator 12 after the state illustrated in FIG. 7A when the scanner unit 3 is tilted to the open position. As illustrated in FIG. 7B, when the scanner unit 3 is tilted to the open position, the indicator 12 changes from being in a lit state to being a flashing state and the operation button 10 changes the indication from the non-light-emitting state to the light-emitting state. Then, the flashing state of the indicator 12 and the light-emitting state of the operation button 10 indicate to the user that after the ink cartridge has been replaced, the operation button 10 should be pushed down. When the operation button 10 is pushed down, a control unit (not shown) can recognize that an ink cartridge has been replaced and then the control unit can carry out an ink-suction operation and the like.

As described above, since the user interface of the operation panel 9 is changed in response to the open position and closed position of the scanner unit 3, the user interface becomes more user-friendly. The control unit (not shown) controls switching between off, on, and flashing operations of the indicators 11 and 12, and switching between the light-emitting operation and the non-light-emitting operation of the operation button 10.

It should be noted that the respective embodiments described above are examples and the invention is not limited to these embodiments. In particular, in the embodiments, the invention is applied to an ink jet printer that is an example of the recording apparatus. However, the invention can be generally applied to another liquid ejecting apparatus.

The liquid ejecting apparatus is not limited to a recording apparatus such as a printer, a copying machine, a facsimile, and the like that eject an ink onto the recording medium from an ink jet type recording head. The liquid ejecting apparatus includes an apparatus that ejects a liquid, which is used rather than ink and corresponds to an application purpose, onto a medium corresponding to a recording medium from a liquid ejection head corresponding to the ink jet type recording head so as to cause the liquid to adhere to the medium.

The liquid ejection head may be selected from among a recording head, a coloring-material ejection head to be used in order to produce, for example, a color filter for a liquid crystal display, an electrode material (an electric conductive paste) ejection head to be used in order to form an electrode for an organic EL display, a surface light-emitting display (FED), and a biological organic body ejection head to be used in order to produce biochips, a sample ejection head that serves as a precision pipette, and the like.

The entire disclosure of Japanese Patent Application No. 2012-011009, filed Jan. 23, 2012 and the entire disclosure of Japanese Patent Application No. 2012-011011, filed Jan. 23, 2012 are expressly incorporated by reference herein.

What is claimed is:

1. A recording apparatus comprising:
an apparatus main body including a recording device that performs a recording operation on a medium;
a scanner unit pivotably mounted on a top portion of the apparatus main body and configured to be openable and closable when the scanner unit is tilted; and
an operation panel unit provided on the scanner unit so as to tilt together with the scanner unit;
wherein, when the scanner unit is in a closed position, the operation panel unit defines a front face of the recording apparatus and a lower edge of the operation panel unit defines an ejection port that ejects the medium recorded by the recording device.

2. The recording apparatus according to claim 1,
wherein the apparatus main body includes an ejection unit that is located at a side near the front face of the recording apparatus away from the recording device and that ejects the medium toward the front face of the recording apparatus,
wherein the ejection unit includes a first roller and a second roller that contacts the first roller in a downward direction,
wherein the second roller is supported by a frame that extends laterally in the recording apparatus, and
wherein an upper edge of the frame defines a lower edge of an access port when accessing an inner area of the recording apparatus from the front face thereof in a front elevation view of the recording apparatus.

3. The recording apparatus according to claim 1,
wherein heights of top faces of a right side structural member and a left side structural member that define right and left edges of the ejection port decrease toward the front face of the recording apparatus.

4. The recording apparatus according to claim 1,
wherein the operation panel unit is pivotably mounted on the scanner unit.

5. The recording apparatus according to claim 1,
wherein a panel face of the operation panel unit is inclined upward when the scanner unit is tilted to an open position by a given opening angle.

6. The recording apparatus according to claim 5,
wherein, when the scanner unit is in the open position, a direction in which an operation panel of the operation panel unit is pushed intersects a direction in which the scanner unit closes when a user operates the operation panel unit.

7. The recording apparatus according to claim 5,
wherein a user interface of the operation panel of the operation panel unit is changed in accordance with the open and closed positions of the scanner unit.
